(19) United States
(12) Patent Application Publication
(10) Pub. No.: US 2002/0087302 A1
(43) Pub. Date: Jul. 4, 2002

(54) Processing system, processing method and recording medium

(76) Inventor: Miyuki Tomaru, Kawasaki (JP)

Correspondence Address: STAAS & HALSEY LLP, 700 11TH STREET, NW, SUITE 500, WASHINGTON, DC, 20001, US

(21) Appl. No.: 09/815,054

(22) Filed: Mar. 23, 2001

(30) Foreign Application Priority Data
Nov. 10, 2000 (JP) 2000-344389

(51) Int. Cl. G06F 17/20

(52) U.S. Cl. 704/8

(57) ABSTRACT

A processing system includes a module of specifying environment setting information, corresponding to each application program on a dialog screen displayed for each of a plurality of application programs, used and shared for processing, and a module of making the processing executable by use of the specified environment setting information. This architecture makes it possible to reduce a processing time and save a user's labor.

### BACKGROUND OF THE INVENTION

The present invention relates generally to a processing system in which pieces of environment setting information are used for processing, and more particularly to a translation processing system in which pieces of environment setting information on dictionary setting, grammar setting and a translation mode are used for a translation process.

With a spread of the Internet at the present, the users are able to readily obtain articles of the latest news in a great variety of fields from overseas through news distribution services utilizing Web sites and E-mails from overseas. The easy-to-obtain articles of the overseas news are described in foreign languages different from the mother tongue, and therefore the users are hard to comprehend the contents of the articles.

To obviate this drawback, there is utilized a machine translation system for translating sentences in the foreign language into the mother tongue, i.e., translating an original text described in a certain language into another desired language.

In the case of translating a document containing the articles of the news in the great variety of fields by use of the machine translation system as described above, the translation process is executed by setting environment setting information on the dictionary setting, the grammar setting and the translation mode corresponding to a field to which each sentence or text (translation target text) contained in the document is related.

In the translation process by the conventional machine translation system (translation processing system), the user needs to minutely set the environment setting information on the desire-for-use dictionary setting, the grammar setting and the translation mode each time the translation target text changes.

Further, once the setting is done, the translation is executed under the same environment condition, and it is therefore required that the environment setting information be set again each time the translation application software (program) is changed.

Another problem is that even when the environment setting is done, this setting is effective in only this machine translation system, or the environment setting can not be changed unless the translation process is finished once.

In the case of performing similar settings as usual, it must be troublesome to the user that the environment setting is changed each time the translation application software is booted, and this is time-consuming differently from the translating operation essentially needed.

### SUMMARY OF THE INVENTION

Accordingly, it is a primary object of the present invention to provide a processing system, a processing method and a recording medium capable of reducing a processing time.

It is another object of the present invention to provide a processing system, a processing method and a recording medium capable of sharing information with other processing systems.

To accomplish the above objects, according to a first aspect of the present invention, a processing system comprises a module of specifying environment setting information, corresponding to each application program on a dialog screen displayed for each of a plurality of application programs, used and shared for processing, and a module of making the processing executable by use of the specified environment setting information.

According to a second aspect of the present invention, a processing system comprises a module of specifying environment setting information, in a plurality of application programs on a screen common to the plurality of application programs, used and shared for processing, and a module of making the processing executable by use of the specified environment setting information.

According to a third aspect of the present invention, the above processing system may further comprise a module of specifying default environment setting information used for processing in each of the plurality of application programs.

According to a fourth aspect of the present invention, in the above processing system, the environment setting information set in each of the plurality of application programs, may be stored in a file.

According to a fifth aspect of the present invention, in the above processing system, the environment setting information may be information on a dictionary and a grammar used for a translation process.

According to a sixth aspect of the present invention, a processing system comprises a module of specifying environment setting information, corresponding to a plurality of application programs on a screen common to the plurality of application programs, used and shared for processing, and a module of making the processing executable by use of the specified environment setting information.

According to a seventh aspect of the present invention, the above processing system may further comprise a module of specifying default environment setting information used for processing in each of the plurality of application programs.

According to an eighth aspect of the present invention, in the above processing system, the environment setting information set in each of the plurality of application programs, may be stored in a file.

According to a ninth aspect of the present invention, in the above processing system, the environment setting information may be information on a dictionary and a grammar used for a translation process.

According to the present invention, the environment can be determined per application program, the processing can be executed in a variety of environments in parallel.

Further, according to the present invention, the created environment can be transferred to other processing systems, and the information can be shared therewith.

Moreover, according to the present invention, the environment with a high frequency of use is stored per application program and is not therefore required to be selected again when in processing, or the frequency of the environment can be decreased.

Still further, according to the present invention, it is feasible to reduce the processing time and save a user's labor.

### BRIEF DESCRIPTION OF THE DRAWINGS

The foregoing and other features and advantages of the present invention will become more readily appreciated as the same becomes better understood by reference to the following detailed description when taken into conjunction with the accompanying drawings wherein:

FIG. 1 is a block diagram showing an architecture of a translation processing system in one embodiment of the present invention;

FIG. 2 is a diagram showing one example of a main window;

FIG. 3 is an explanatory diagram showing a dictionary tool button on the main window;

FIG. 4 is an explanatory diagram showing an environment setting button on the main window;

FIG. 5 is a diagram showing one example of a translation environment setting screen;

FIG. 6 is a diagram showing one example of a screen for setting a default translation environment name;

FIG. 7 is a diagram showing one example of a detail setting (dictionary setting) screen;

FIG. 8 is a diagram showing one example of an English-Japanese setting screen;

FIG. 9 is a diagram showing one example of a Japanese-English setting screen;

FIG. 10 is a diagram showing one example of an update/new creation confirmation screen;

FIG. 11 is a diagram showing one example of a translation editor screen;

FIG. 12 is a diagram showing one example of a file translation screen;

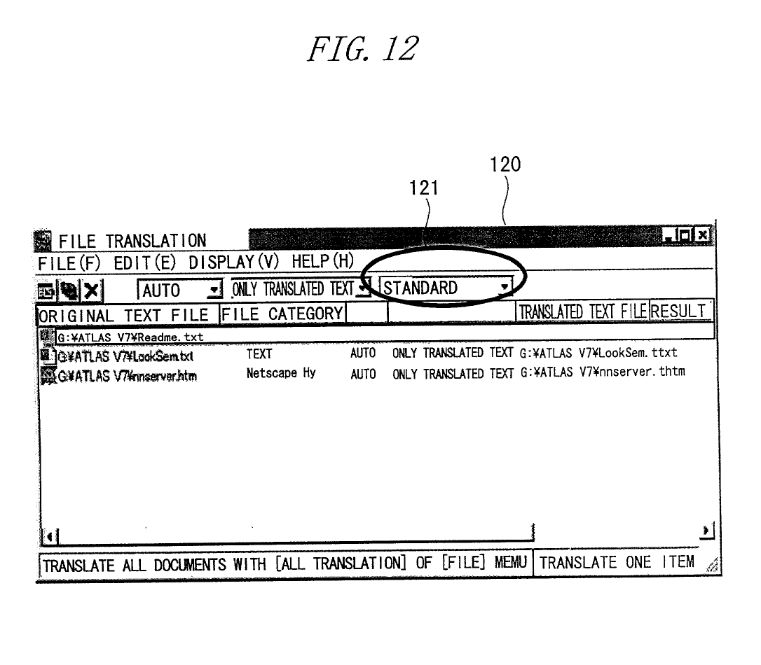

FIG. 13 is a diagram showing one example of a homepage translation screen;

FIG. 14 is a diagram showing one example of a dictionary tool (word search and delete) screen;

FIG. 15 is a diagram showing one example of environment setting items (translated sentence style of English-Japanese translation);

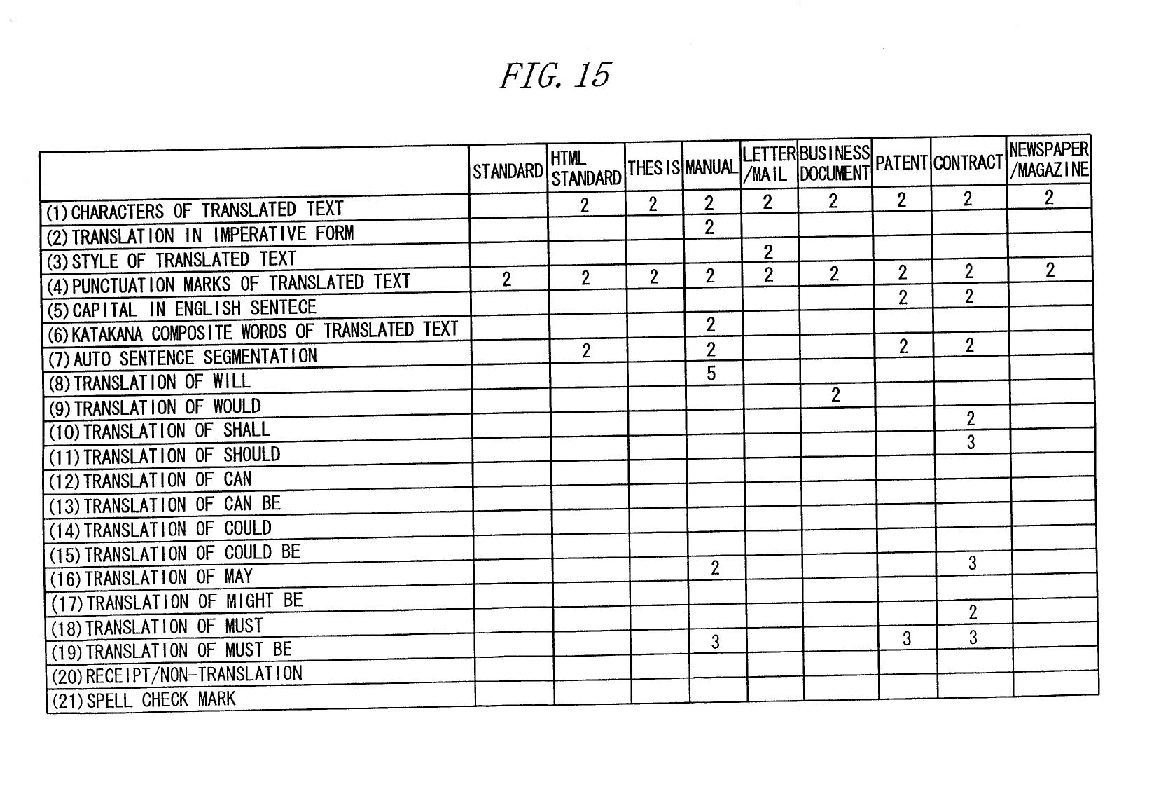

FIG. 16 is an explanatory diagram showing an operational example of a translation processing system;

FIG. 17 is an explanatory diagram showing processing steps of the translation processing system;

FIG. 18 is a diagram showing one example of a file for storing the environment;

FIG. 19 is an explanatory diagram showing processing steps of the translation processing system;

FIG. 20 is an explanatory diagram showing the processing steps of the translation processing system; and

FIG. 21 is an explanatory diagram showing the processing steps of the translation processing system.

### DETAILED DESCRIPTION OF THE PREFERRED EMBODIMENTS

Next, embodiments of the present invention will hereinafter be described with reference to the accompanying drawings.

[Architecture of Translation Processing System]

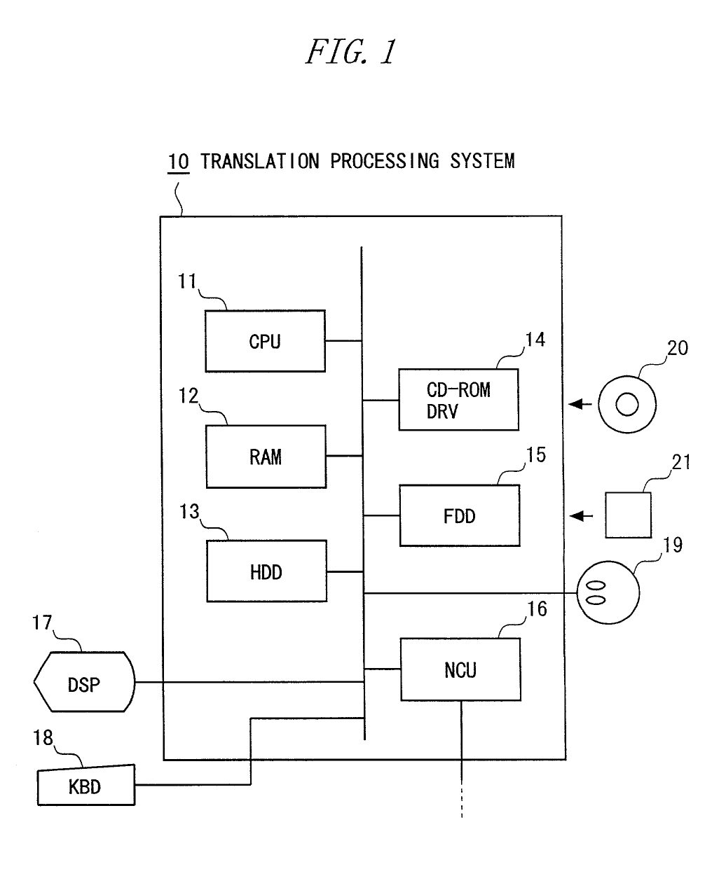

FIG. 1 shows an architecture of a translation processing system in one embodiment of the present invention. Referring to FIG. 1, a translation processing system (computer) 10 includes a CPU 11, a RAM 12, a hard disk drive (HDD) 13, a CR-ROM drive 14, a floppy disk drive (FDD) 15, and a network control unit (NCU) 16 such as a network card and a MODEM.

A display 17 is connected via an unillustrated graphic board to the translation processing system 10. A keyboard 18 and a mouse 19 are also connected via unillustrated interfaces to the translation processing system 10. A communication line is connected to the NCU 16.

A program for controlling the translation processing system 10 is developed on the RAM 12. The RAM 12 is used for storing a result of program-based processing and temporary data for processing. The hard disk drive 13 and the floppy disk drive 15 are devices for recording the programs and control data on recording mediums (which are a hard disk and a floppy disk 21) corresponding thereto.

The CD-ROM drive 14 is used for reading the data and the program stored in the CD-ROM 20. The network control unit 16 is used for transmitting and receiving the data with other NCUs via the communication lines and for downloading the program.

The keyboard 18 consists of a plurality of character keys and arrow keys, and is used for inputting various items of data. The mouse 19 is used for manipulating a mouse cursor and giving a selective indication through the mouse cursor displayed in the screen of the display 17.

The program containing processes according to the present invention that are executed by the translation processing system 10 as the computer, is previously stored in the CD-ROM 20 through the CD-ROM drive 14 or in floppy disk 21 through the floppy disk drive 15 or in the hard disk through the hard disk drive 13. Further, the NCU 16 may control the hard disk drive 13 via the network (not shown) to store the same program in the hard disk.

Then, the program given above is downloaded into the RAM 12 in accordance with a predetermined indication, and the respective units of the translation processing system 10 are thereby controlled to execute the processes according to the present invention.

Note that the hard disk in the translation processing system 10 is stored with sentence delimiter information for delimiting sentence wise a translation target document received from each translation application software (which will here in after be simply referred to as an application in some cases) and information for environment setting information for each sentence.

Further, the hard disk in the translation processing system 10 is stored with translation oriented dictionaries for translating languages, and syntax oriented dictionaries for analyzing syntaxes, and these dictionaries are used for processes of translating texts received from the respective applications.

[Functions of Translation Processing System]

(Main Window and Other Screens)

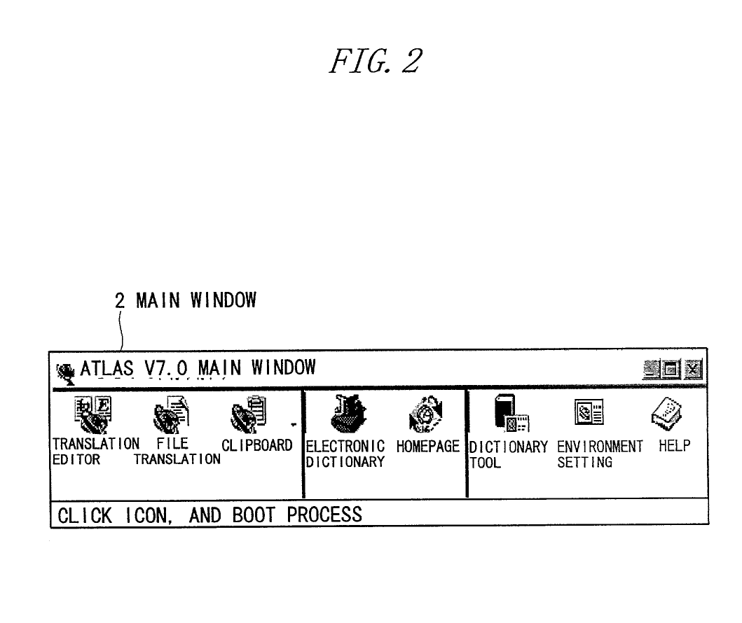

FIG. 2 shows one example of a main window displayed on the display 17 of the translation processing system 10. Note that the following discussion proceeds on the assumption that “Windows” (registered trademark), Microsoft Corp., is used as an operating system for the computer in the first embodiment.

This main window (initial screen) 2 can be booted from a start menu and then displayed. A button layout on the main window 2 is that a translation editor, a file translation, a clipboard translation and a homepage translation are arranged in a toolbar format which are all compatible with the translation application software.

Further, on the main window 2, a dictionary tool button for register, searching and deleting words and for registering batchwise the dictionary, and an environment setting button are arranged in the toolbar format. [Setting of dictionary], [recognition of one sentence] and [translated sentence style] in the translation environment are, though will be described later on in greater details, selected in a dropdown menu by clicking the [environment setting] button down to [translation environment setting].

Herein, the following functions are executed by selecting the respective buttons.

Translation editor: Booting of translation editor

File translation: Booting of file translation screen

Clipboard translation: Translation of a content on the clipboard

Homepage translation; Booting of homepage translation screen

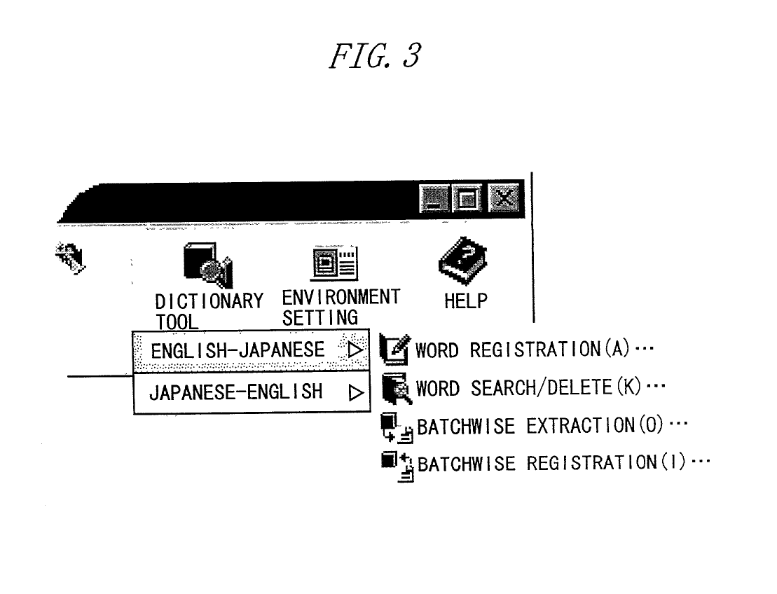

Further, when the dictionary tool button is selected, the screen for searching, registering and deleting the words is booted. As shown in FIG. 3, the following four functions are provided with respect to English-Japanese and Japanese-English translations.

Word registration: Execution of registering words

Word search: Execution of searching and deleting words

Batchwise extraction: Extraction and outputting of contents of user dictionary to file

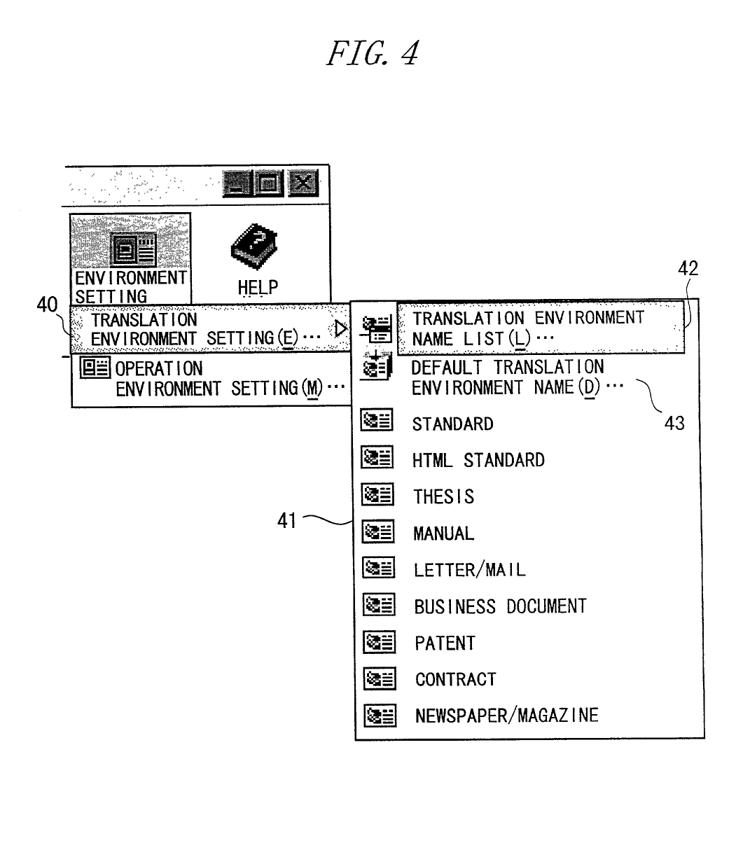

Moreover, when the environment setting button is selected, a translation environment setting screen and a detail setting screen as to the dictionary and translated sentence style, are booted. Herein, as shown in FIG. 4, when selecting the [translation environment setting] 40, a dropdown menu 41 of [translation environment name] is pulled down.

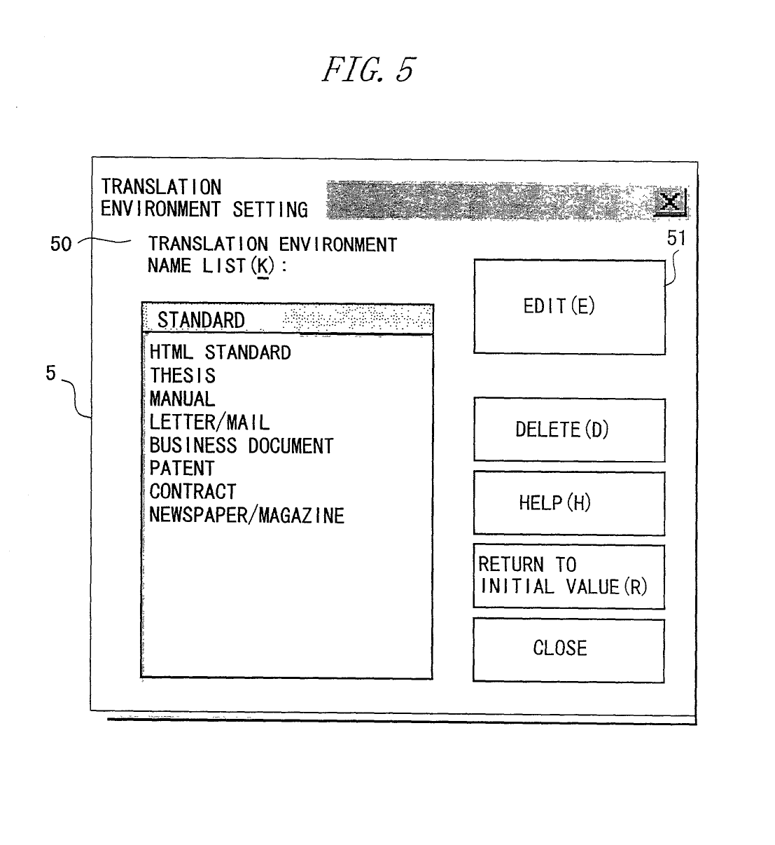

When a [translation environment name list] 42 is selected in this menu, as shown in FIG. 5, a translation environment name list 50 registered with the translation environments at the present, is displayed. The translation environment name may be created, deleted and updated based on operations in this dialog box displayed. Herein, when selecting an [edit] button 51, there is displayed a detail setting screen 7 for changing the setting of or newly creating the dictionary and the translated sentence style in the selected translation environment name. When selecting a [delete] button, the selected translation environment name is deleted. The translation environment name set when installing the program according to the present invention, is however, undeletable. When a [return to initial value] button is selected, the setting of the selected translation environment name is returned to the initial setting when installed.

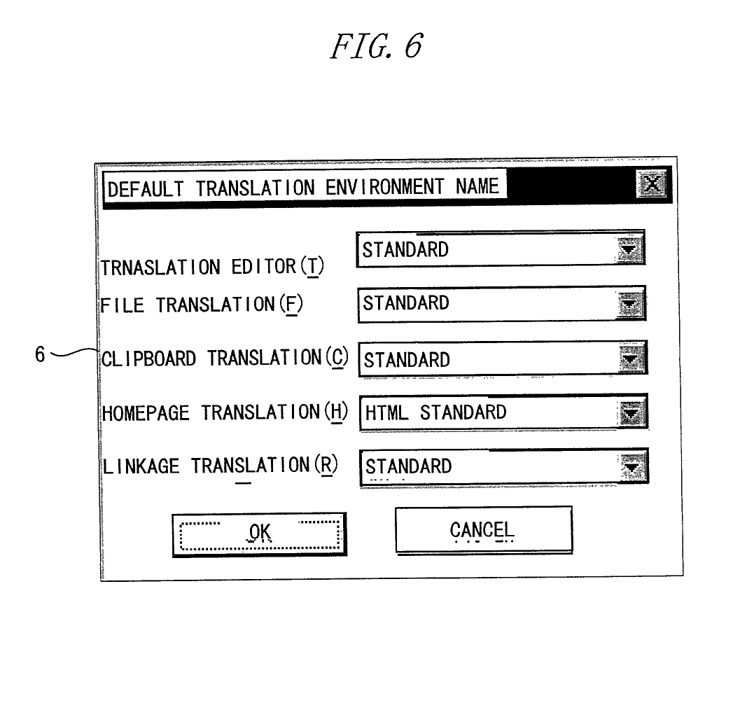

When selecting a [default translation environment name] 43 in the dropdown menu 41 of the environment name shown in FIG. 4, as shown in FIG. 6, default environment names of respective translation functions are displayed. The default environment names can be specified based on operations in this dialog box displayed.

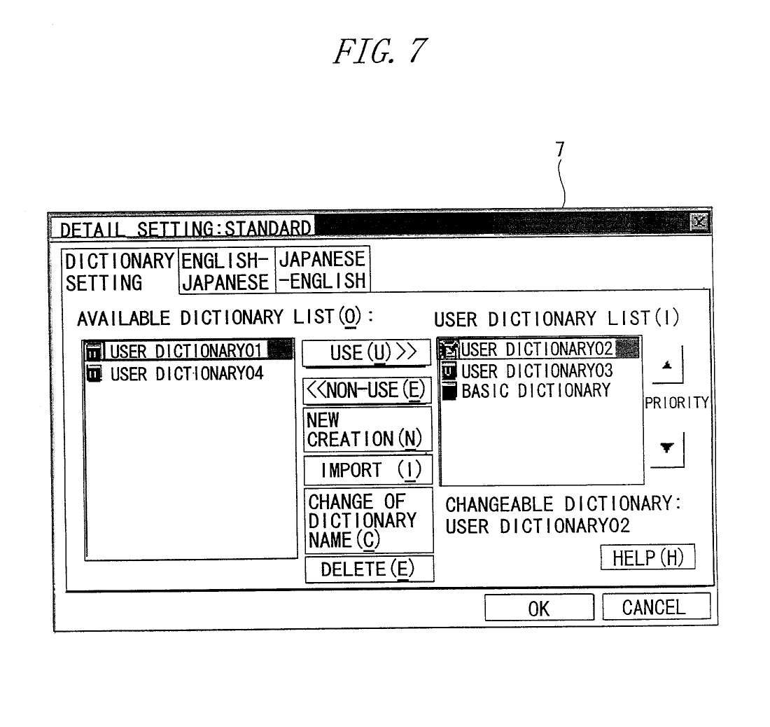

On the detail setting screen 7 shown in FIG. 7, a dictionary used for the translation process can be selected from the dictionaries (user dictionaries and terminology dictionaries) installed. Namely, the user dictionary is created or deleted, the dictionary name is changed, and so on.

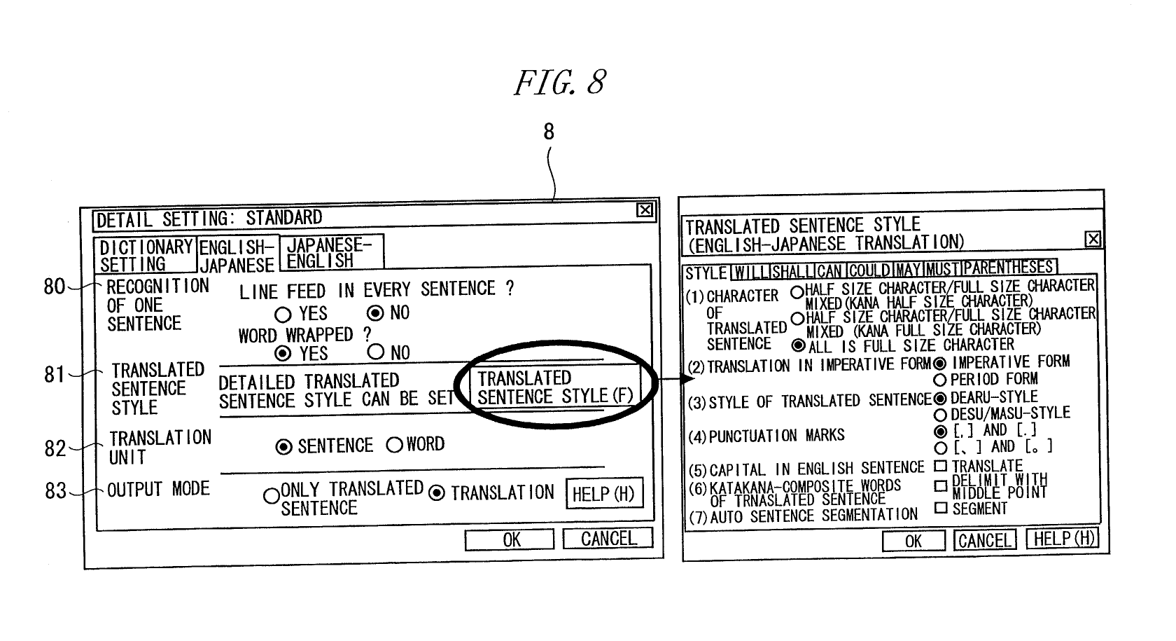

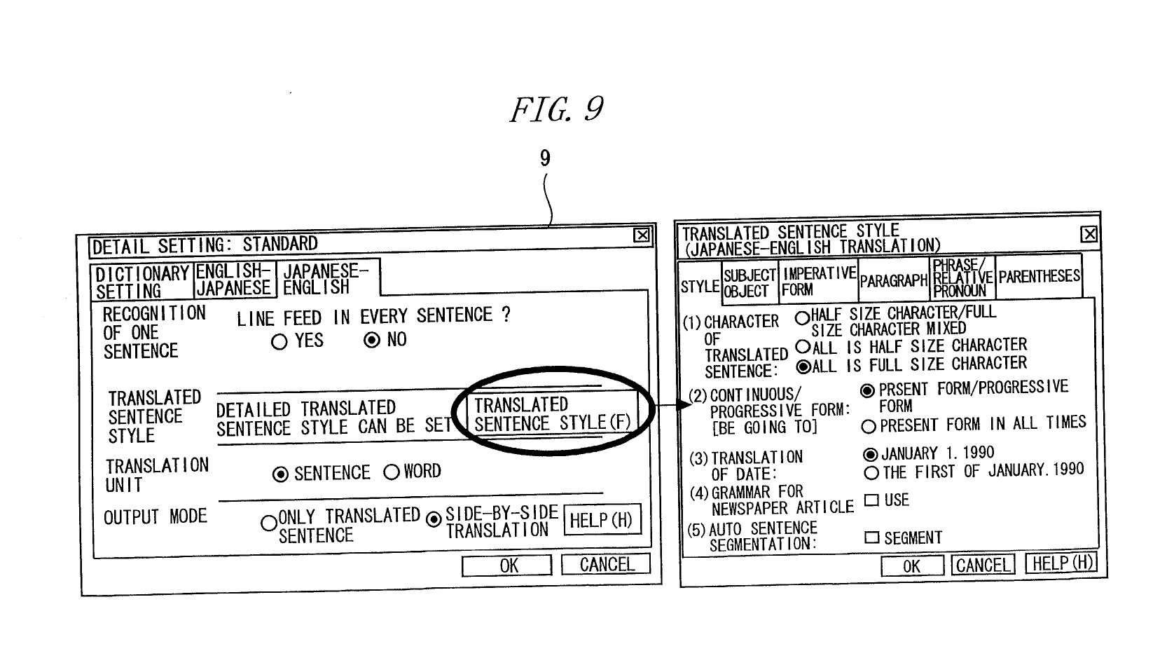

Further, on an English-Japanese setting screen 8 and a Japanese-English setting screen of the detailed setting screen, as shown in FIGS. 8 and 9, a recognition of one sentence and a translated sentence style (grammar) can be set. Herein, in an item of [recognition of one sentence] 80, when the original text is read by the translation editor, it is set how a line feed is treated and so forth. In an item of [translated sentence style] 81, the translated sentence style can be set in detail. In an item of [translation unit] 82, it is set whether a translation mode is based on the sentence or word. Further, in an item of [output mode] 83, it is set whether the translated text is outputted in a translation mode together with the original text or in an only-translated-text mode.

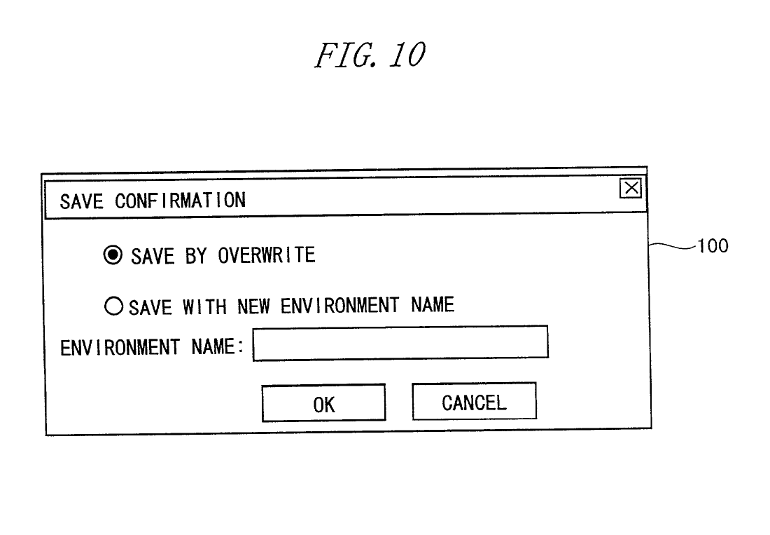

FIG. 10 shows one example of an update/new creation confirmation screen 100. When selecting an [OK] button on the detail setting screens 7, 8, 9 for the dictionaries and grammars, a save confirmation screen is displayed. Herein, when clicking [save by overwrite], the created environment setting is saved by overwriting. At this time, an operation status is that none of new environments can be inputted. Further, when clicking [save with new environment name] ,the created environment setting is saved given a new name.

(Translation Editor)

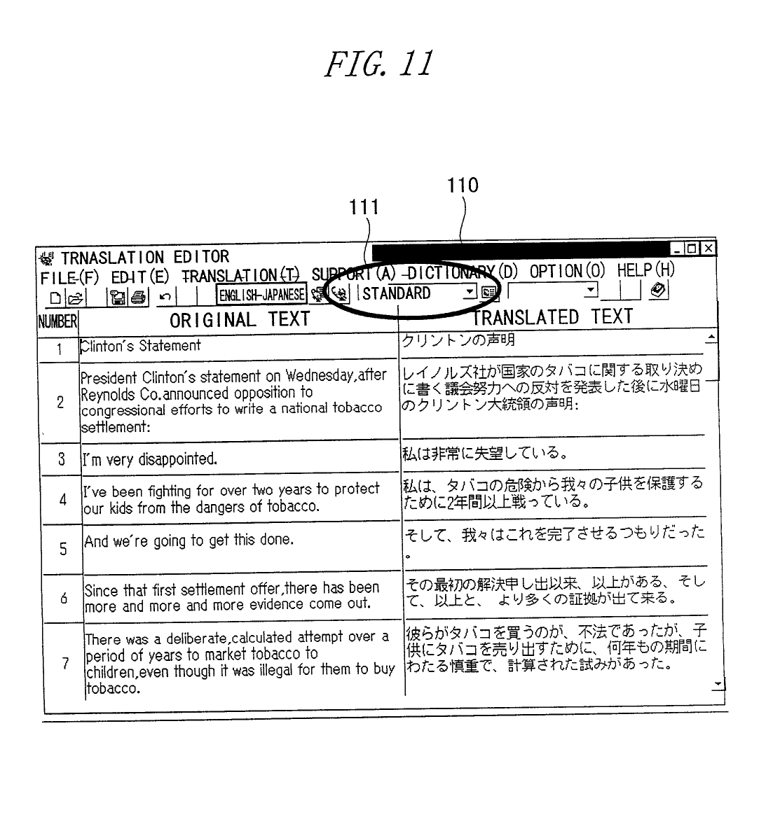

The translation editor defined as the translation application software has a function of translating the original text in a way of editing the original and translated texts so that the original sentence and the translated sentence are displayed in a side-by-side relationship. FIG. 11 shows one example of a dialog screen 110 with the translation editor. On the dialog screen 110 with the translation editor, a list box 111 in which the translation environment name can be selected, is displayed.

(File Translation)

A file translation defined as the translation application software has a function of translating a plurality of files batchwise. On a dialog screen 120 of the file translation, an environment name to be used can be selected per document. That is, the dictionary setting and the translated sentence style are changeable. Therefore, a list box 121 in which the translation environment name can be selected is displayed in the tool bar on the dialog screen 120.

(Clipboard Translation)

A clipboard translation defined as the translation application software functions to copy a desire-for-translation sentence to a clipboard and, when clicking a [clipboard translation] button on the main window 2, display a translated result on the screen. This screen is provided with no button for setting the environment.

(Homepage Translation)

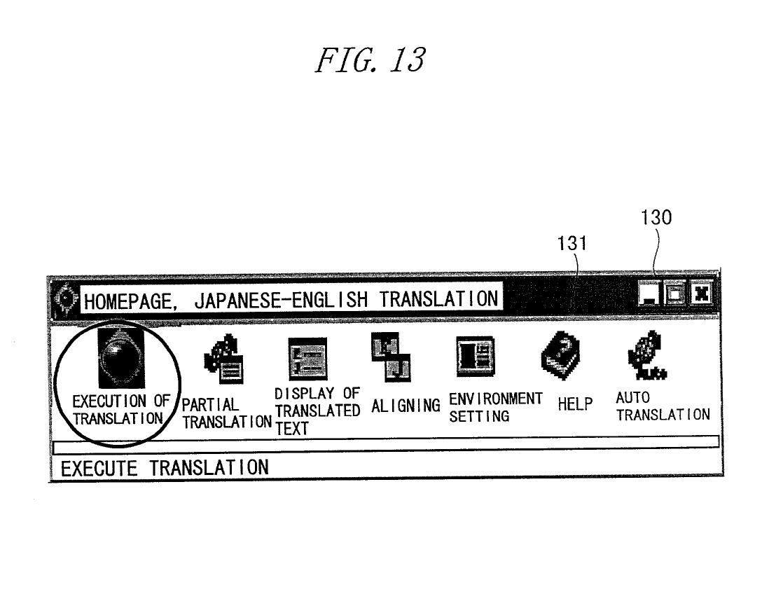

A homepage translation as the translation application software functions to translate a homepage while its layout is stored. On this homepage translation screen, as shown in FIG. 13, an [environment setting] button 131 in the tool bar is selected, whereby the environment settings such as the dictionary setting and the grammar setting can be done.

(Dictionary Tool: Word Search and Delete)

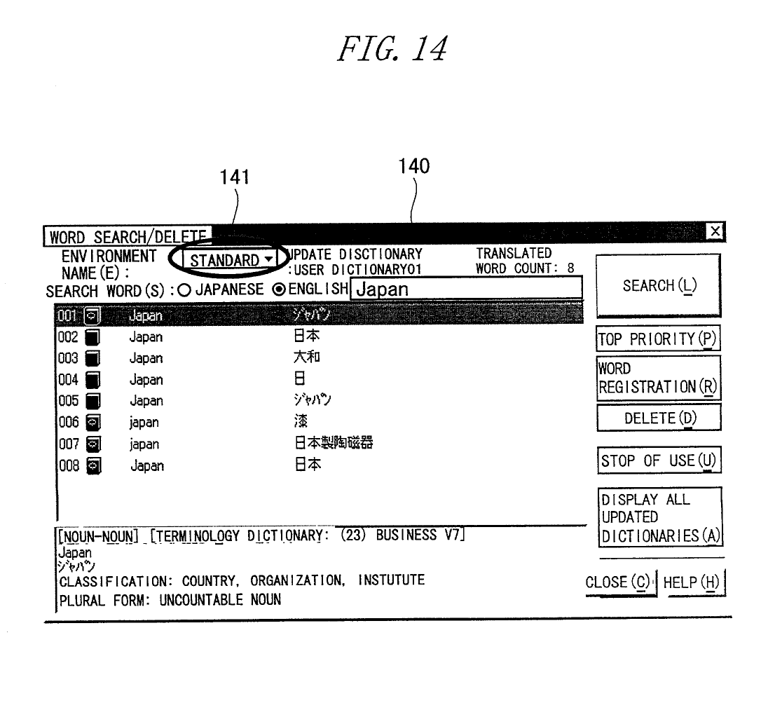

FIG. 14 shows a word search/delete screen 140 of the dictionary tool. A combo box 141 for selecting the environment name is provided in this screen 140. Results of searching the words are outputted in the order of priority of the on-use dictionary set on the environment setting screen (see FIG. 7)

(Environment Setting)

Environment setting may be defined as a function for storing a tuple of the on-use dictionary, the translated sentence style and the recognition of one sentence as a [translation environment], and translating the text by selecting it on each application.

The selection box of the translation environment name is provided for each of the applications such as the translation editor, the file translation etc, thereby making it possible to change the dictionary setting and the grammar setting simply by the user's selecting the preset translation environment name without resetting details of the dictionary setting and of the grammar setting. The tuple of the dictionary setting and the grammar setting can be saved, changed and deleted on the translation environment setting screen (FIGS. 5˜9).

The tuple of the on-use dictionary, the translated sentence style and the recognition of one sentence is stored as one environment in the environment setting. The setting is saved as an ini file (e.g., transenv.ini) in a predetermined folder on the program, and this is a contrivance that the user is unable to directly edit.

Further, a tenvseed.ini file is prepared as a template of the translation environment in an install folder, and, if there does not exist the above file or when reset to the initial value, a translation environment name is created from this tenvseed.ini file.

When installed, a tuple of the translated sentence styles shown in is stored in the file as a default environment. The user is able to add or change the dictionary setting herein.

The default environment of the homepage default environment is [HTML standard], and [standard] is default for other applications.

[Operations of Translation Processing System]

Next, a variety of operational examples of the translation processing system 10 in one embodiment of the present invention illustrated in FIG. 1, will be explained.

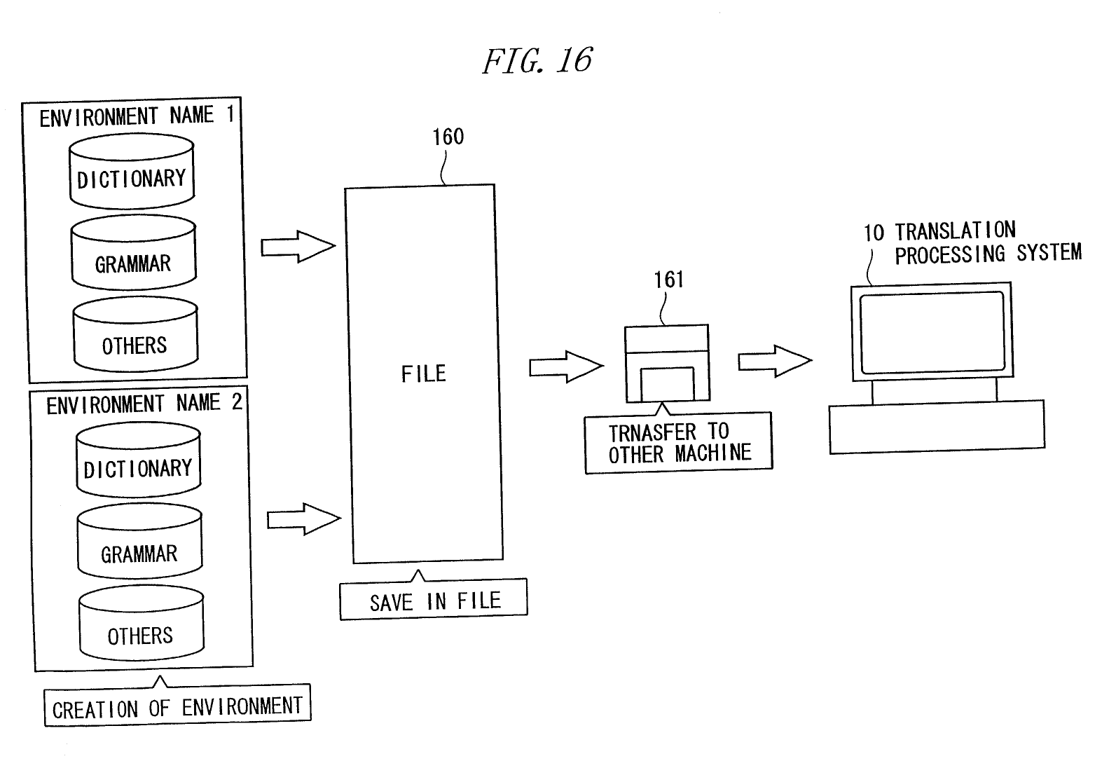

In the translation processing system 10, as shown in FIG. 16, a tuple of environment settings such as the dictionary setting, the grammar setting and a translation mode that have an influence on the translated result, is stored given a environment name (environment names 1, 2) in a file 160. A plurality of environments are stored batchwise in one single file 160. If the file 160 is transferred in the form of its being on a hard disk or floppy disk 161 to an environment of other translation processing system 10, the same environment can be shared with other translation processing systems.

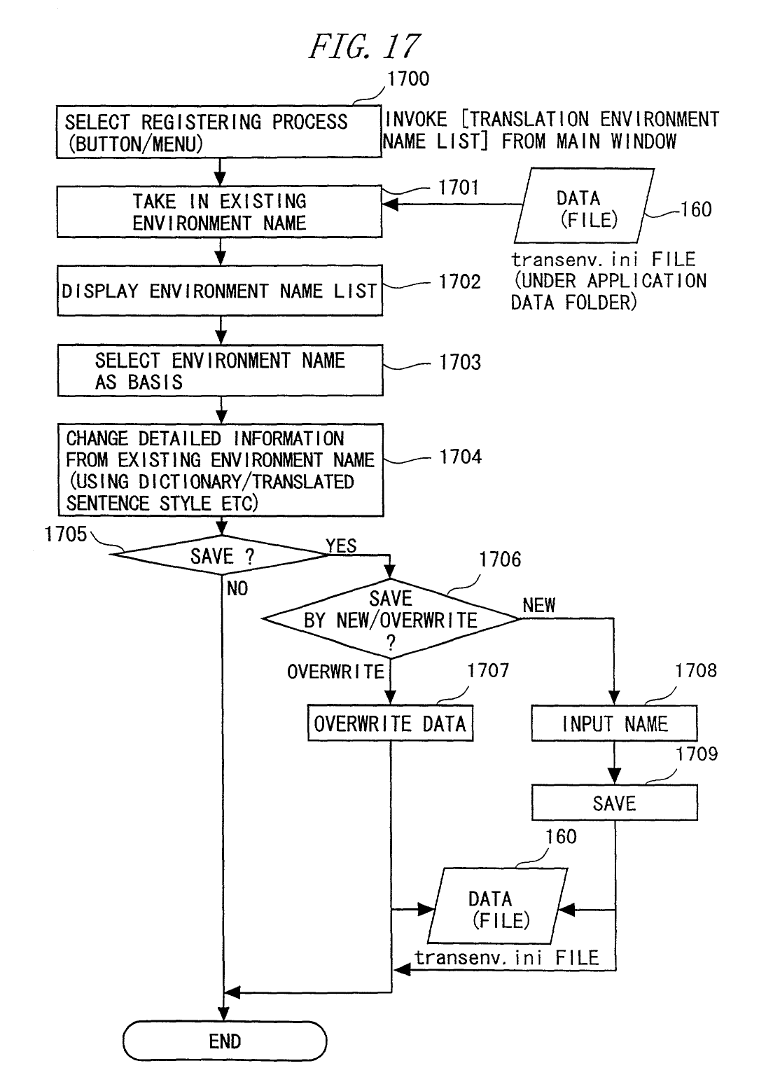

FIG. 17 shows processing steps of newly registering the environment. The user invokes the translation environment name list 41 shown in FIG. 4 from the main window 2 of the translation processing system 10 shown in FIG. 2 (1700).

In the translation processing system 10, the existing environment names are retrieved from the file (transenv.ini file under the application data folder) (1701). Then, a translation environment name list 50 is displayed on the translation environment setting screen 5 shown in FIG. 5 (1702).

The user, based on the display of this environment name list, selects an environment name as a basis (1703). Next, the detailed information is changed from the existing environment names on the detail setting screens 7, 8, 9 with respect to the dictionaries and the grammars shown in FIGS. 7, 8 and 9 (1704).

On the update/new creation confirmation screen 100, when selecting [save by overwrite] for the environment setting created by the user, the environment setting created is saved by overwriting in the file 160 (1705˜1707).

Further, when selecting [save with new environment name] the created environment setting is saved given a name afresh (1705, 1706, 1708, 1709).

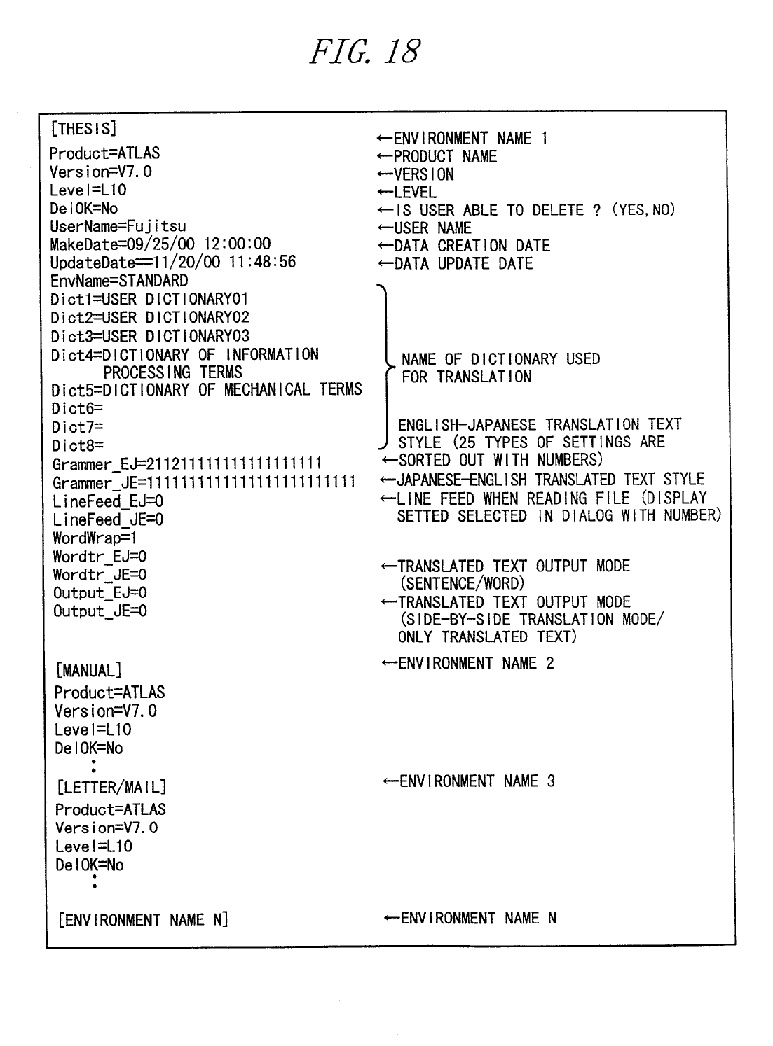

Note that FIG. 18 shows one example of a data structure of the file (transenv.ini file) 160.

Next, in the translation processing system 10, the environment name is set per application, and the translation can be executed simultaneously in a variety of environments.

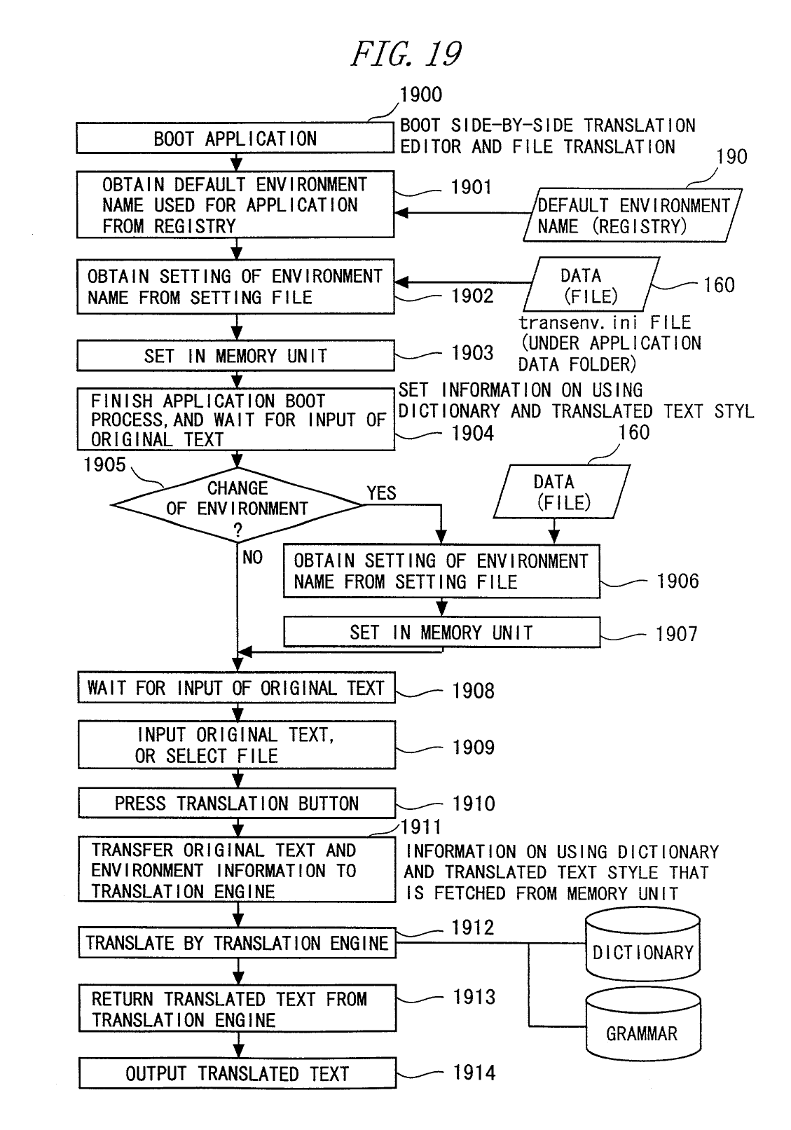

FIG. 19 shows processing steps making use of the environment for the translation. The application such as the translation editor or the file translation is booted (1900). Then, the default environment name used in the application is obtained from a registry 190 (1901).

Next, each setting of the environment is obtained from the setting file 160 (1902), and the information on the user dictionary and the translated sentence style is set in a memory unit (1903). An application boot process is thus ended, and the processing comes to a wait-for-the-original-text status (1904).

If there is a change of the environment, each setting of the environment name is obtained from the setting file 160 (1906) the information on the user dictionary and the translated sentence style is set in the memory unit (hard disk, floppy disk) (1907).

If there is no change of the environment in step 1905, or after step 1907 is finished, there comes to the wait-for-the-original-text status (1908). When the original text is inputted, or when the file selection is made, the original text and the environment information are transferred to a translation module (translation engine) (1911) by pressing (selecting) a translation button (1910).

The translation module executes a translation process by use of the environment setting information on the dictionary setting and the grammar setting (1912). When the translated text is sent back to the application from the translation module (1913), the application outputs the translated text in a predetermined format (1914).

A series of these translation processes will be explained in greater details.

(1) When the user indicates an execution of translation, the application such as the translation editor, the file translation etc segments the processing target document (text) on a processing unit of the translation module, e.g., on a sentence-by-sentence basis.

(2) After segmenting the original text sentence by sentence, the application requests the translation module to translate one sentence of the original text on the basis of respective pieces of environment setting information defined in the selected environment. Further, there exist the plurality of applications making the translation request, and hence the translation module is notified of an identification number for identifying the application as a translation requester.

(3) The translation module translates the original text in response to the translation request received from the application, and sends a translated result back to the requester application.

(4) The application and the translation module repeat the processes (2) and (3), thereby translating all the sentences of the translation processing target documents.

(5) When all the sentences of the processing target document are translated, the application outputs the translated result based on an out put mode determined by the same application. For example, the translation editor displays the translated text and the original text side by side on the screen. Further, according to the file translation, the translated text is outputted to a file.

Next, according to the translation processing system 10, the environment name set when booting is stored per application in the registry or the file. Therefore, the environment name with a high frequency of use can be stored per application, and the user does not need to reselect each time when in the booting process. The default environment name is set not from each application but on the main window 2.

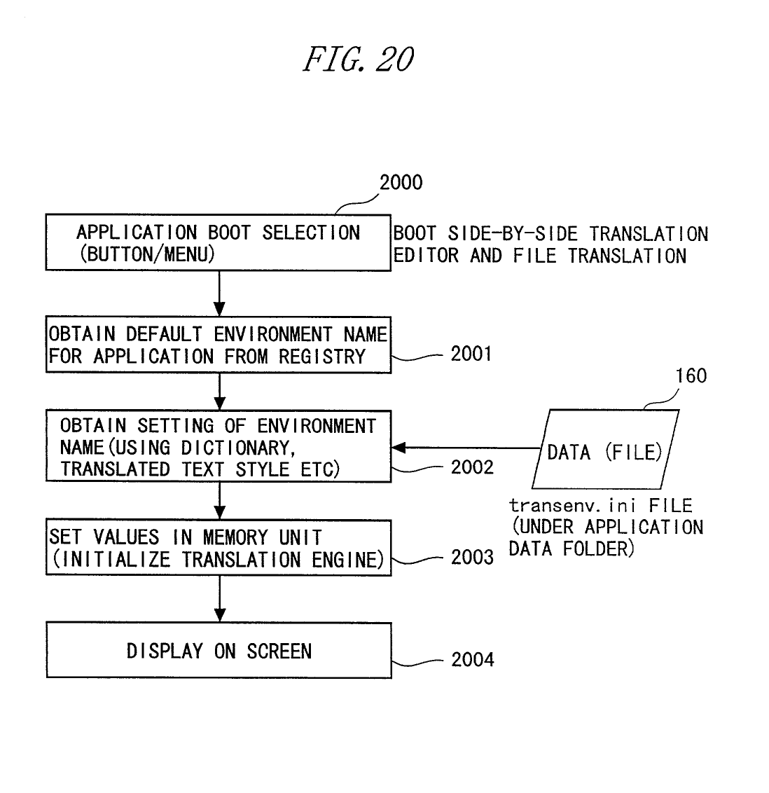

FIG. 20 shows steps of a process of displaying the default environment name and executing initialization when booting the application. On the main window 2, the boot of application is selected (2000) and the default environment name of the application is obtained from the registry 190 (2001).

Each setting of the environment name is obtained from the file 160 (2002), and respective set values are set in the memory unit (the translation module is initialized) (2003). This state is displayed on the default translation environment name setting screen 6 shown in FIG. 6 (2004).

The default translation environment name has a registry value for every user who uses the translation processing system 10. The following is one example of the registry values.

HKEY-CURRENT-USER

:
+ ATLAS

+− Application name 1

Name [DEFAULT ENV]
DEFAULT ENV value [Environment name 1]

+− Application name 2

Name [DEFAULT ENV]
DEFAULT ENV value [Environment name 2]

+− :

Note that a location for storing the environment name determined for every application may be either the registry or the file.

Next, according to the translation processing system 10, the environment name is, when searching a word, specified in the combo box 141 on the word search screen 140 of the dictionary tool shown in FIG. 14 m thereby searching the word in the order of priority of the on-use dictionary per environment. Namely, the environment name used for the translation is specified when searching the word, thereby making it feasible to search from the often-used environment.

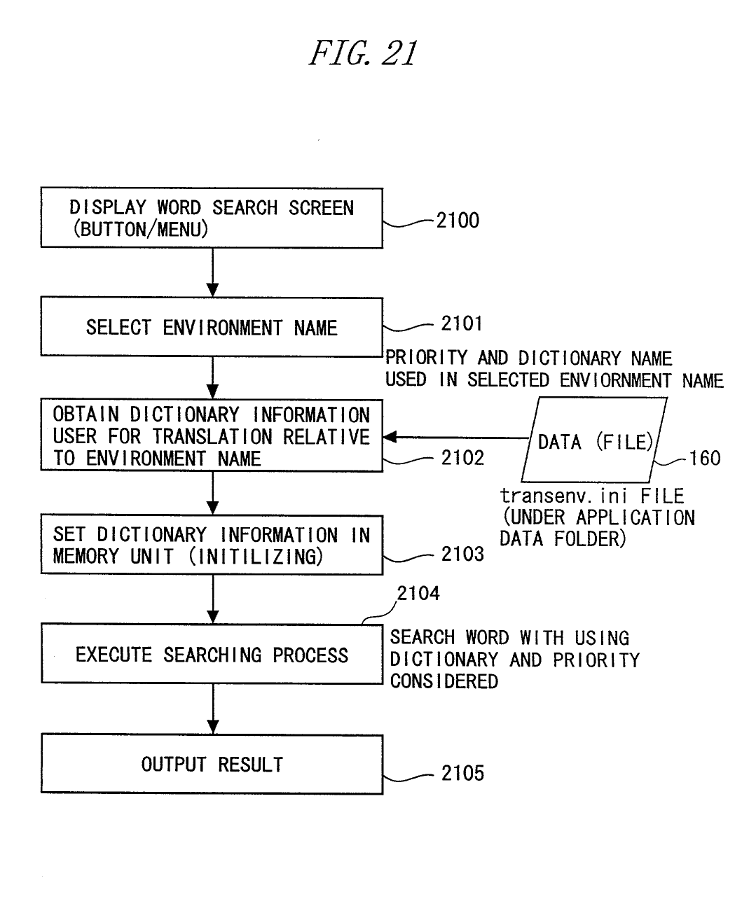

FIG. 21 shows steps of the word searching process. The word searching screen 140 is displayed to prompt the user to select an environment name (2100, 2101). The dictionary information (the dictionary name, the priority) used with this selected environment name is obtained from the file 160 (2102). Then, the thus obtained dictionary information is set in the memory unit (2103).

The application searches the word in consideration of the dictionary used and the priority as well (2104), and outputs a result thereof (2105).

[Modified Example]

The embodiment discussed above has exemplified the translation processing system in which pieces of environment setting information on the dictionary setting, the grammar setting and translation mode, are used for the translation process. The present invention can be, however, embodied in other processing systems used for processing the information on the environment setting.

Although only a few embodiments of the present invention have been described in detail above, those skilled in the art will readily appreciate that many modifications are possible in the preferred embodiments without departing from the novel teachings and advantages of this invention. Accordingly, all such modifications are intended to be included within the scope of the present invention as defined by the following claims.

What is claimed is:

1. A processing system comprising:
a module of specifying environment setting information, corresponding to each application program on a dialog screen displayed for each of a plurality of application programs, used and shared for processing; and
a module of making the processing executable by use of the specified environment setting information.

2. A processing system comprising:
a module of specifying environment setting information, in a plurality of application programs on a screen common to said plurality of application programs, used and shared for processing; and
a module of making the processing executable by use of the specified environment setting information.

3. A processing system according to claim 1, further comprising a module of specifying default environment setting information used for processing in each of said plurality of application programs.

4. A processing system according to claim 1, wherein the environment setting information set in each of said plurality of application programs, is stored in a file.

5. A processing system according to claim 1, wherein the environment setting information is information on a dictionary and a grammar used for a translation process.

6. A processing system according to claim 2, wherein the environment setting information set in each of said plurality of application programs, is stored in a file.

7. A processing method, comprising:
specifying environment setting information, corresponding to each application program on a dialog screen displayed for each of a plurality of application programs, used and shared for processing; and
making the processing executable by use of the specified environment setting information.

8. A processing method, comprising:
specifying environment setting information, in a plurality of application programs on a screen common to said plurality of application programs, used and shared for processing; and
making the processing executable by use of the specified environment setting information.

9. A processing method according to claim 7, further comprising specifying default environment setting information used for processing in each of said plurality of application programs.

10. A processing method according to claim 7, further comprising storing a file with the environment setting information set in each of said plurality of application programs.

11. A processing method according to claim 7, wherein the environment setting information is information on a dictionary and a grammar used for a translation process.

12. A processing method according to claim 8, further comprising storing a file with the environment setting information set in each of said plurality of application programs.

13. A processing method according to claim 8, wherein the environment setting information is information on a dictionary and a grammar used for a translation process.

14. A readable-by-computer recording medium recorded with a program, executed by a computer, comprising:
a step of specifying environment setting information, corresponding to each application program on a dialog screen displayed for each of a plurality of application programs, used and shared for processing; and
a step of making the processing executable by use of the specified environment setting information.

15. A readable-by-computer recording medium recorded with a program, executed by a computer, comprising:
a step of specifying environment setting information, in a plurality of application programs on a screen common to said plurality of application programs, used and shared for processing; and
a step of making the processing executable by use of the specified environment setting information.

16. A readable-by-computer recording medium recorded with a program executed by a computer according to claim 14, further comprising a step of specifying default environment setting information used for processing in each of said plurality of application programs.

17. A readable-by-computer recording medium recorded with a program executed by a computer according to claim 14, further comprising a step of storing a filed with the environment setting information set in each of said plurality of application programs.

18. A readable-by-computer recording medium recorded with a program executed by a computer according to claim 14, wherein the environment setting information is information on a dictionary and a grammar used for a translation process.

19. A processing system comprising:
a module of specifying environment setting information, corresponding to a plurality of application programs on a screen common to said plurality of application programs, used and shared for processing; and
a module of making the processing executable by use of the specified environment setting information.

20. A processing system according to claim 19, further comprising a module of specifying default environment setting information used for processing in each of said plurality of application programs.

21. A processing system according to claim 19, wherein the environment setting information set in each of said plurality of application programs, is stored in a file.

22. A processing system according to claim 19, wherein the environment setting information is information on a dictionary and a grammar used for a translation process.

23. A processing method, comprising:
specifying environment setting information, corresponding to a plurality of application programs on a screen common to said plurality of application programs, used and shared for processing; and
making the processing executable by use of the specified environment setting information.

24. A processing method according to claim 23, further comprising specifying default environment setting information used for processing in each of said plurality of application programs.

25. A processing method according to claim 23, further comprising storing a file with the environment setting information set in each of said plurality of application programs.

26. A processing method according to claim 23, wherein the environment setting information is information on a dictionary and a grammar used for a translation process.

27. A readable-by-computer recording medium recorded with a program, executed by a computer, comprising:
a step of specifying environment setting information, corresponding to a plurality of application programs on a screen common to said plurality of application programs, used and shared for processing; and
a step of making the processing executable by use of the specified environment setting information.

28. A readable-by-computer recording medium recorded with a program executed by a computer according to claim 27, further comprising a step of specifying default environment setting information used for processing in each of said plurality of application programs.

29. A readable-by-computer recording medium recorded with a program executed by a computer according to claim 27, further comprising storing a file with the environment setting information set in each of said plurality of application programs.

30. A readable-by-computer recording medium recorded with a program executed by a computer according to claim 27, wherein the environment setting information is information on a dictionary and a grammar used for a translation process.
